(19) United States
(12) Patent Application Publication
(10) Pub. No.: US 2009/0098887 A1
(43) Pub. Date: Apr. 16, 2009

(54) Mobile terminal and location information acquisition method thereof

(75) Inventor: Seok Jun Baek, Suwon-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/286,459

(22) Filed: Sep. 30, 2008

(30) Foreign Application Priority Data
Oct. 10, 2007 (KR) 2007-0101894

(51) Int. Cl. H04W 64/00

(52) U.S. Cl. 455/456.1

(57) ABSTRACT

A mobile terminal and location information acquisition method thereof is provided for facilitating registration of a mobile terminal for a location service and locating the mobile terminal using a SIM Application Toolkit (SAT). A location information acquisition method of the present invention includes registering, when a terminal registration menu item provided by the SIM is selected, an intended terminal indicated by a name and a phone number entered by a user with the SIM; selecting, when a location request menu item provided by the SIM is selected, one of terminals registered with the SIM according to the user's intention; and acquiring location information of the selected terminal, the location information being received in response to a location information request transmitted by the mobile terminal. The location information acquisition method for a mobile terminal according to the present invention enables acquires location information of a specific mobile terminal in a cost-effective manner through a simplified manipulation of menu items provided by SAT of SIM card.

### CROSS-REFERENCE TO RELATED APPLICATION(S) AND CLAIM OF PRIORITY

The present application claims priority to an application entitled “MOBILE TERMINAL AND LOCATION INFORMATION ACQUISITION METHOD THEREOF” filed in the Korean Intellectual Property Office on Oct. 10, 2007 and assigned Serial No. 2007-0101894, the contents of which are incorporated herein by reference.

### TECHNICAL FIELD OF THE INVENTION

The present invention relates to a mobile terminal and, in particular, to a mobile terminal and location information acquisition method thereof that enables facilitating registration of a mobile terminal for a location service and locating the mobile terminal using a SIM Application Toolkit (SAT).

### BACKGROUND OF THE INVENTION

The mobile location service is one of the significant issues for providing subscribers with security particularly in emergency state. Recently, various positioning mechanisms have been developed and adopted for mobile location services.

Most of current mobile location services are provided on the basis of a wireless application protocol (WAP), such that a subscriber has to maintain a connection to a WAP server to use the mobile location service. In the meantime, the WAP-based mobile location services are pay services. Accordingly, every use of the mobile location service is charged, resulting in additional communication cost for maintaining the WAP connection.

### SUMMARY OF THE INVENTION

To address the above-discussed deficiencies of the prior art, it is a primary object to provide a mobile terminal and location information acquisition method thereof that enables cost-effective use of mobile location service using SAT provided by a SIM card.

Also, the present invention provides a mobile terminal and location information acquisition method thereof that is capable of facilitating registration of a mobile terminal for a location service and locating the mobile terminal using SAT provided by a SIM card.

Also, the present invention provides a mobile terminal and location information acquisition method thereof that is capable of effectively locating a mobile terminal using a set of commands provided by SAT.

In accordance with an exemplary embodiment of the present invention, a location information acquisition method for a mobile terminal operating with a subscriber identity module (SIM) having a SIM Application Toolkit includes registering, when a terminal registration menu item provided by the SIM is selected, an intended terminal indicated by a name and phone number entered by a user with the SIM; selecting, when a location request menu item provided by the SIM is selected, one of terminals registered with the SIM according to user's intention; and acquiring location information of the selected terminal, the location information being received in response to a location information request transmitted by the mobile terminal.

In accordance with another exemplary embodiment of the present invention, a mobile terminal includes a subscriber identity module (SIM) having a SIM Application Toolkit (SAT) which provides the mobile terminal with menu items; a control unit which registers, when a terminal registration menu item provided by the SIM is selected, an intended terminal indicated by a name and phone number entered by a user with the SIM, selects, when a location request menu item provided by the SIM is selected, one of terminals registered with the SIM according to user's intention, requests location information to the intended terminal, and analyzes the location information received from the selected terminal; and a display unit which displays, when the location request menu item is selected, information on the mobile terminal registered with the SIM, and displays, when receiving the location information, the location information analyzed by the control unit.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a conceptual view illustrating a mobile communication system for use in a location information acquisition method according to an exemplary embodiment of the present invention;

FIG. 2 is a perspective view illustrating a mobile terminal according to an exemplary embodiment of the present invention;

FIG. 3 is a block diagram illustrating a configuration of a mobile terminal according to an exemplary embodiment of the present invention;

FIG. 4 is a flowchart illustrating a location information acquisition method according to an exemplary embodiment of the present invention;

FIG. 5 is a message flow diagram illustrating a terminal registration procedure of a location information acquisition method according to an exemplary embodiment of the present invention; and

FIG. 6 is a message flow diagram illustrating a location request procedure of a location information acquisition method according to an exemplary embodiment of the present invention.

### DETAILED DESCRIPTION OF THE INVENTION

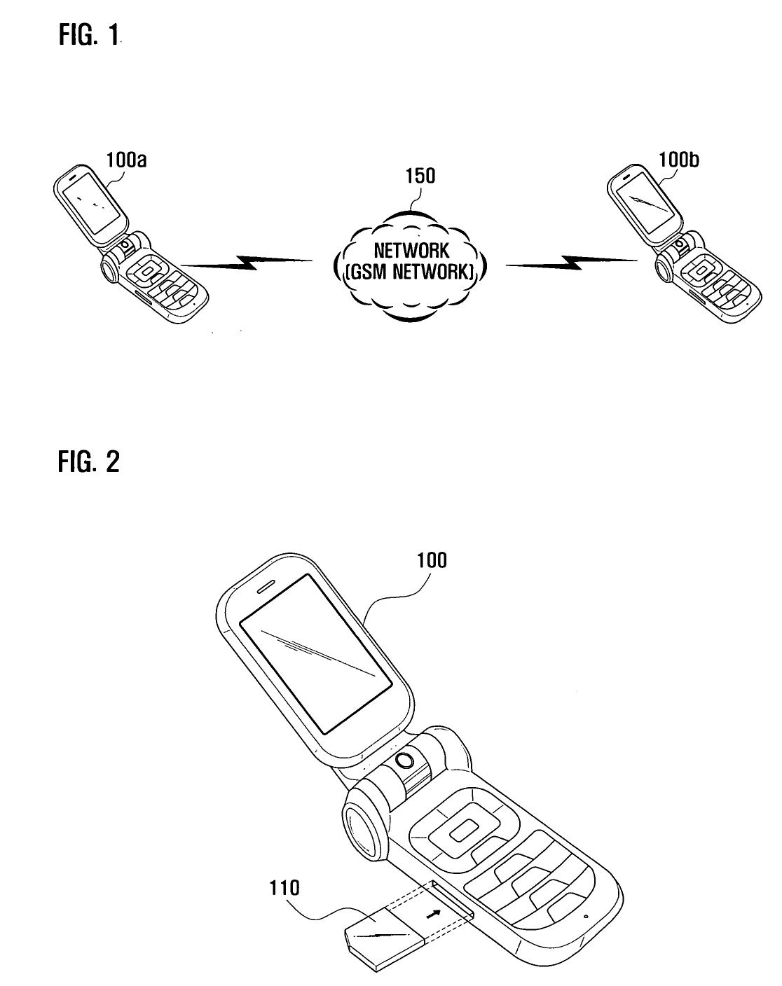

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged mobile terminal.

In the following, the mobile location information acquisition method is described in the context of a Global System for Mobile communication (GSM) mobile terminal. The mobile terminal represents a mobile phone, portable multimedia player (PMP), personal digital assistant (PDA), smartphone, laptop computer, and their equivalent devices having mobile communication functions.

FIG. 1 is a conceptual view illustrating a mobile communication system for use in a location information acquisition method according to an exemplary embodiment of the present invention, and FIG. 2 is a perspective view illustrating a mobile terminal according to an exemplary embodiment of the present invention.

Referring to FIG. 1, the mobile communication system includes a plurality of mobile terminals 100a and 100b associated with a network 150. Although two mobile terminals are depicted in FIG. 1, the number of mobile terminals is not limited thereto.

Each of the mobile terminals 100a and 100b supports short message service (SMS) and multimedia message service (MMS), and has a camera module for taking pictures and an MP3 module for playing MP3 files.

Preferably, the mobile terminals 100a and 100b are GSM terminals. There are two competing cellular network technologies: code division multiple access (CDMA) and GSM. GSM networks are popular in most European countries and CDMA is dominant in North America and South Korea. Unlike the CDMA, the GSM uses time division multiple access (TDMA). The GSM network is composed of GSM mobile station, base station subsystem (BSS), and other network components.

As shown in FIG. 2, a GSM mobile terminal 100 is provided with a subscriber identity module (SIM) card 110. The term “GSM mobile station” is interchangeably used with “mobile terminal”. The SIM card 110 is removable so as to be used with another mobile terminal. The mobile terminal 100 has an international mobile equipment identity (IMEI), and the SIM card has an international mobile subscriber identity (IMSI). The IMEI and IMSI are used to identify the mobile terminal 100 and subscriber during an authentication process with a network. That is, the IMEI and IMSI are independent, thereby allowing personal mobility.

In this embodiment, the mobile terminal 100 is configured to use the mobile location service for acquiring location information of itself or another mobile terminal. When a terminal registration menu or a location request menu is selected on the first mobile terminal 100a having the SIM card 110, the mobile terminal 100a allows entering a name and phone number of a mobile terminal (the second mobile terminal 100b in FIG. 1) and transmitting a service registration request message to the second mobile terminal 100b. If a service registration response message is received, the first mobile terminal 100a registers the second mobile terminal 100b with the location service. If a location request menu is selected after registration of the second mobile terminal 100b, the first mobile terminal 100a can acquire the location information of the second mobile terminal 100b.

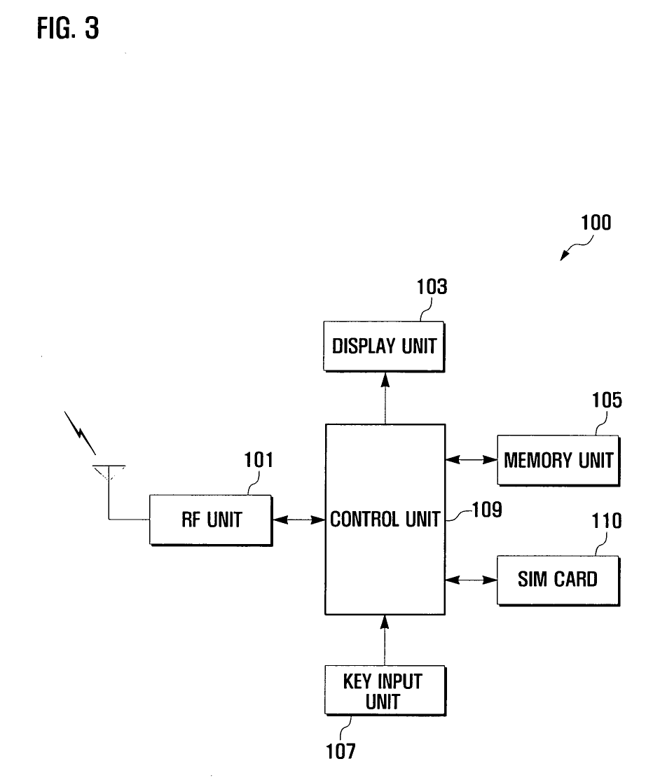

FIG. 3 is a block diagram illustrating a configuration of a mobile terminal according to an exemplary embodiment of the present invention.

Referring to FIG. 3, the mobile terminal 100 includes a radio frequency (RF) unit 101, a display unit 103, a memory unit 105, a key input unit 107, a control unit 109, and a SIM card 110. This configuration can be applied to the mobile terminals 100a and 100b in FIG. 1.

The RF unit 101 is responsible for radio communication of the mobile terminal 100. The RF unit 101 is provided with an RF transmitter for up-converting and amplifying frequency signals to be transmitted and an RF receiver for low noise amplifying and down-converting received frequency signals.

The RF unit 101 enables the mobile terminal to communicate with another mobile terminal via the network 150. If a service target terminal is selected on an available terminal list, the mobile terminal 100 transmits a service registration request message to the service target terminal. The mobile terminal 100 also can receive a service registration response message transmitted by the service target terminal by means of the RF unit 101. If a location request menu item, which is provided by the SIM card 110, is selected, the mobile terminal 100 requests the service target terminal to transmit its location information. The mobile terminal 100 receives the location information of the service target terminal through the RF unit 101.

The display unit 103 displays information about the operation status of the mobile terminal 100. Particularly in this embodiment, the display unit 103 displays various menu items provided by the SIM card 110 and a menu screen associated with selected menu item. The display unit of the service target terminal displays a popup message for asking whether to accept or reject the service registration request. The display unit of the service target terminal also displays, when receiving a location request message from the mobile terminal 100, a service alert message notifying the receipt of the location request message. In a case when a specific option is set, the alert message may not be displayed. This is useful when the mobile location function is used for finding a missing person because the alert message may put the person carrying the service target terminal in danger. Accordingly, it is preferred that the location request alert function can be disabled optionally.

The memory unit 105 stores application programs and data associated with the operations of the mobile terminal 100. Particularly in this embodiment, the memory unit 105 stores information on the service target terminals registered for the mobile location service. The service target terminal information can be stored in at least one of the memory unit 105 and the SIM card 110. The location of the service target terminal information can be selected by the user and stored in a predetermined format. In this embodiment, it is assumed that the service target terminal information is stored in the SIM card 110.

The key input unit 107 is provided with a plurality of key for allowing the user to input command for controlling the operation of the mobile terminal. The key input unit 107 allows selecting a terminal registration menu, inputting information about the service target terminal, selecting location request menu, selecting one of terminals registered for the location service, and establishing a WAP connection using received location information.

The control unit 109 controls operations of the internal units of the mobile terminal 100. Particularly in this embodiment, the control unit 109 controls the location information acquisition procedure. When the terminal registration menu item, which is provided by the SIM card 110, is selected, the control unit 109 registers a terminal with subscriber's name and phone number input through the key input unit 107. Also, if the service registration response message is received, the control unit 109 displays the information and registers the terminal for the location service. In a case that a specific option is configured, mobile terminal 100 can register the terminal for the location service regardless of the receipt of the service registration response message. This is useful when finding a missing terminal since the owner of the missing terminal can register the missing terminal forcibly.

The control unit 109 selects a location request menu item among the menu items provided by the SIM card 110, selects one of the terminals listed on a location service available terminal list, and transmits a location request message to the selected service target terminal according to the user's intention. If the location information is received from the service target terminal, the control unit 109 displays the location information on the display unit 103. At this time, the control unit 109 can establish a WAP connection so as to acquire more detailed location information of the service target terminal. The control unit 109 also can display the location of the mobile terminal on a previously stored map.

The SIM card 110 is a memory card including a microprocessor. Typically, the SIM card 110 is inserted into the mobile terminal 100 and is used for identify the subscriber. The information stored in the SIM card 110 can be input and output through the control unit 109 of the mobile phone 100. The SIM card 110 is divided into an authentication information storage part for storing user authentication information and a general storage part for storing general user information.

The SIM card 110 is provided with an operation system (OS) and a SIM Application Toolkit (SAT). The SAT is a European Telecommunication Standards Institute/Special Mobile Group (ETSI/SMG) for Value Added Services and e-commerce using GSM terminals. The SAT is programmed into SIM card 110 in the form of applications suitable for user-requiring services. The SIM card 110 storing the applications acts as a master device, and the mobile terminal 100 acts as a slave device. Accordingly, the mobile terminal 100 executes commands provided by the SIM card 110 and feeds back to the SIM card 110.

Although the location information acquisition method is described with the SIM card 110, the present invention is not limited thereto. For example, the location information acquisition method can be implemented with another type of smartcard such as universal SIM (USIM) card, user identity module (UIM), and removable UIM (RUIM) card.

Now the location information acquisition method of the above structured mobile terminal is described hereinafter.

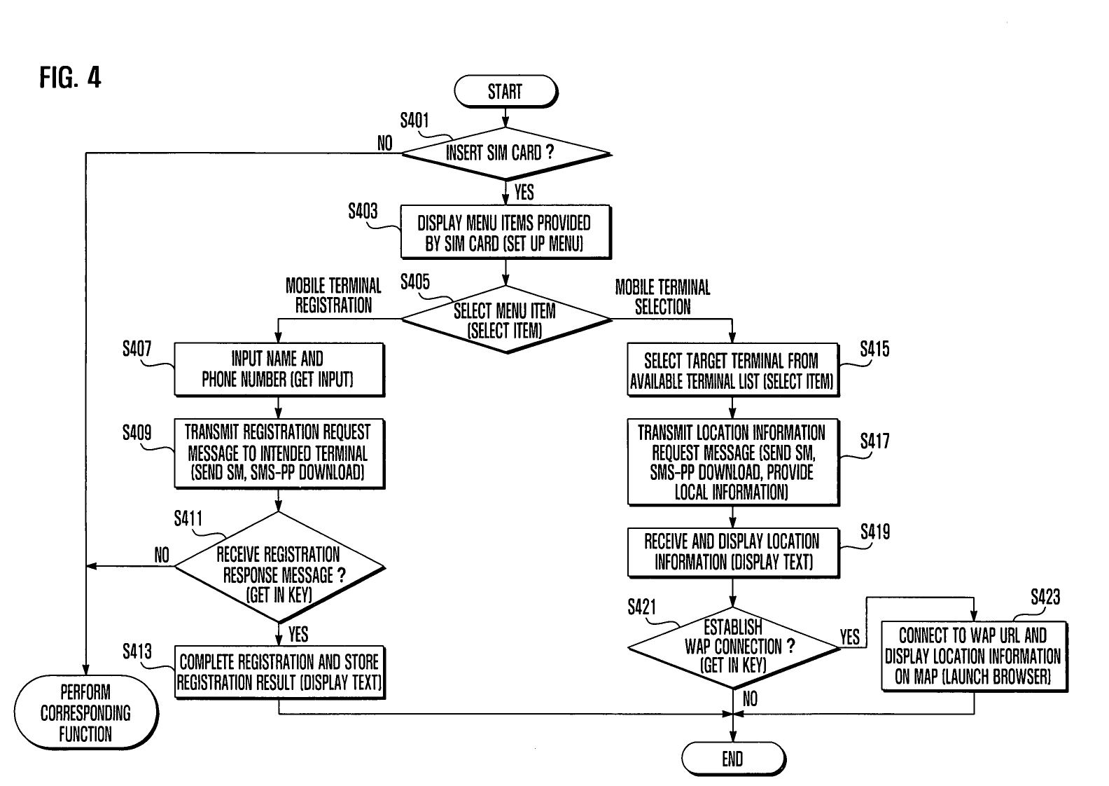

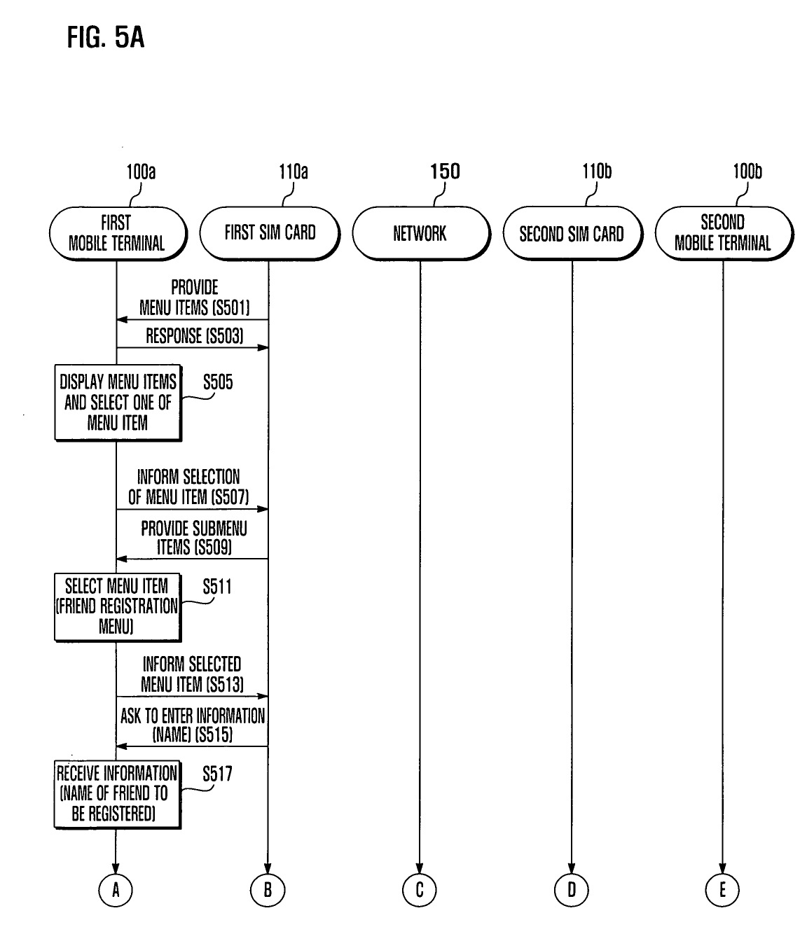

FIG. 4 is a flowchart illustrating a location information acquisition method according to an exemplary embodiment of the present invention.

Referring to FIGS. 1 to 4, the control unit 109 of the first mobile terminal 100a monitors to detect an event and determines, if an event is detected, whether the event is an insertion of the SIM card 110 (S401). The SIM card 110 is inserted into a card slot (not shown) provided at a part of the mobile terminal 100a.

If the SIM card 110 is detected in the card slot, the control unit 109 displays menu items provided by the SIM card 110 on the display unit 103 (S403). The SIM card 110 issues SET UP MENU command supplying a set of menu items to the first mobile terminal 110a, and the first mobile terminal 110a responds with TERMINAL RESPONSE to the SIM card 110, whereby the menu items are displayed on the display unit 103.

While the menu items are displayed, the first mobile terminal 100a detects a selection of one of the menu items and determines whether the selected menu item is a terminal registration menu item or a location request menu item (S405). Here, it is assumed that an SAT menu item is selected by the user such that the first mobile 100a sends a MENU SELECTION command to the SIM card 110. In response to the MENU SELECTION command, the SIM card 110 sends SELECT ITEM command to the first mobile terminal 100a such that the first mobile terminal 100a displays submenu items related to the SAT menu.

From the submenu items, the user can select the terminal registration menu item or location request menu item. If the terminal registration menu item is selected, the control unit 109 sends a command indicating the selection of the terminal registration menu item.

After sending the selection indication command, control unit 109 of the first mobile terminal 100a receives the name and phone number of a terminal (i.e., the second terminal 100b) which is required to be registered for the location service (S407). At this time, the SIM card 110 sends a GET INPUT command. Upon receipt of the GET INPUT command, the first mobile terminal 100a displays a text message for allowing the user to enter information regarding the second mobile terminal 100b.

Next, the first mobile terminal 100a sends a service registration request message to the second mobile terminal 100b of which the phone number is entered by the user (S409). The service registration request message is transmitted from the SIM card 110 of the first mobile terminal 100a to the SIM card of the second mobile terminal 100b by means of a short message service (SMS). That is, the SIM card 110a transmits an SMS message (SEND SM) to the GSM network 150, and the GSM network 150 transmits a SMS-PP DOWNLOAD command to the SIM card of the second mobile terminal 100b. Upon receipt of the SMS-PP DOWNLOAD command, the SIM card of the second mobile terminal 100b sends a GET INPUT command to the second mobile terminal 100b such that the second mobile terminal 100b displays a message asking whether to accept or reject the registration.

After transmitting the service registration request message, the control unit 109 of the first mobile terminal 100a determines whether a service registration response message is received (S411). The service registration response message is transmitted from the SIM card of the second mobile terminal 100b to the SIM card 110 of the first mobile terminal 100a through the SEND SM and SMS-PP DOWNLOAD commands. If a forced registration option is set, the control unit 109 of the first mobile terminal 100a forcibly registers the second mobile terminal 100b for the location service regardless of the receipt of the service registration response message.

If the service registration response message is received, the control unit 109 of the first mobile terminal 100a completes the registration of the second mobile terminal 100b and stores the registration result (S413). At this time, the SIM card 110 sends a DISPLAY TEXT command to the first mobile terminal 100a, and the first mobile terminal 100a sends a Terminal Response of DISPLAY TEXT to the SIM card 110, whereby the first mobile terminal 100a displays the service registration response message on the display unit 103. The information on the second mobile terminal 100b can be stored in the SIM card of the first mobile terminal 100a.

If a location request menu item is selected at step S405, the control unit 109 sends a SELECT ITEM command to the SIM card 110 for notifying that the location request menu item is selected.

Next, the control unit 109 of the first mobile terminal 100a selects a service target terminal from an available terminal list according to the user selection (S415). Here, the SIM card 110 of the first mobile terminal 100a sends the SELECT ITEM command to the first mobile terminal 100a and displays the available terminal list such that the user can select a service target mobile terminal from the list.

If the service target mobile terminal is selected, the control unit 109 of the first mobile terminal 100a transmits a location information request message to the second mobile terminal 100b (S417). Upon receipt of the information on the service target mobile terminal (i.e., second mobile terminal 100b), the SIM card 110 of the first mobile terminal 100a transmits an SMS message to the SIM card of the second mobile terminal 100b via the GSM network 150. That is, the SIM card 110 of the first mobile terminal 100a transmits a SEND SM command to the GSM network 150, and the GSM network 150 transmits a SMS-PP DOWNLOAD command to the SIM card of the second mobile terminal 100b. The SIM card of the second mobile terminal 100b sends a PROVIDE LOCAL INFORMATION command to the second mobile terminal 100b for requesting the second mobile terminal to transmit its location information.

The location of the second mobile terminal 100b can be obtained using a global positioning system (GPS).

Also, the location of the second mobile terminal 100b can be obtained by a trigonometric measurement based on the signals transmitted by three base stations in vicinity. In this case, the system calculates distances between the second mobile terminal 100b and the three base stations using the arrival times of a signal transmitted by the second mobile terminal 100b, and determines the location of the second mobile terminal 100b using triangulation. There are two triangulation-based measurement techniques using the time of arrival (TOA) and time difference of arrival (TDOA).

In the TOA based technique, the distances between the mobile terminal and three base stations estimated on the basis of the signal propagation times from the mobile terminal to the base stations is used. That is, the location of the mobile terminal is a position related to three circles with diameters defined by the distances between the second mobile terminal 100b and the three base stations. In the TDOA based technique, the location of the mobile terminal is determined by more than three hyperbolic curves defined by spots of identical signal strength in association with the base stations.

Also, the location of the second mobile terminal 100b can be estimated using the mobile country code (MCC), mobile network code (MNC), location area code (LAC), and cell ID contained in the PROVIDE LOCAL INFORMATION command.

After transmitting the location information request message, the control unit 109 of the first mobile terminal 100a receives the location information from the second mobile terminal 100b and displays the location information on the display unit 103 (S419). Here, the second mobile terminal 100b provides its SIM card with the location information, and the SIM card transmits the location information to the SIM card 110 of the first mobile terminal 100a through the SEND SM command and SMS-PP DOWNLOAD command. At this time, the SIM card of the second mobile terminal 100b sends a DISPLAY TEXT command to the second mobile terminal 100b, and the second mobile terminal 100b sends Terminal Response of DISPLAY TEXT command so as to notify that the first mobile terminal 100a uses the location service. The location service use notification process can be skipped according to a preset option.

In the meantime, the SIM card 110 of the first mobile terminal 100a sends a DISPLAY TEXT command to the first mobile terminal 100a, and the first mobile terminal 100a sends a Terminal Response of DISPLAY TEXT command and displays the location information of the second mobile terminal 100b on the display unit 103.

Next, the control unit 109 of the first mobile terminal 100a determines whether a WAP connection is required (S421). At this time, the SIM card 110 of the first mobile terminal 100a sends a GET INKEY command to the first mobile terminal 100a such that the first mobile terminal 100a determines whether to display the location on a map.

If a WAP connection request is received, the control unit 109 connects to a URL and displays the location of the second mobile terminal 100b on the map provided at the URL (S423). At this time, the SIM card 110 of the first mobile terminal 100a sends a LAUNCH BROWSER command to the first mobile terminal 100a, and the first mobile terminal 100a sends a Terminal Response of LAUNCH BROWSER command such that the location of the second mobile terminal 100b is displayed on the map provided by the URL.

A terminal registration procedure of the location information acquisition method of the present invention is described hereinafter in more detail.

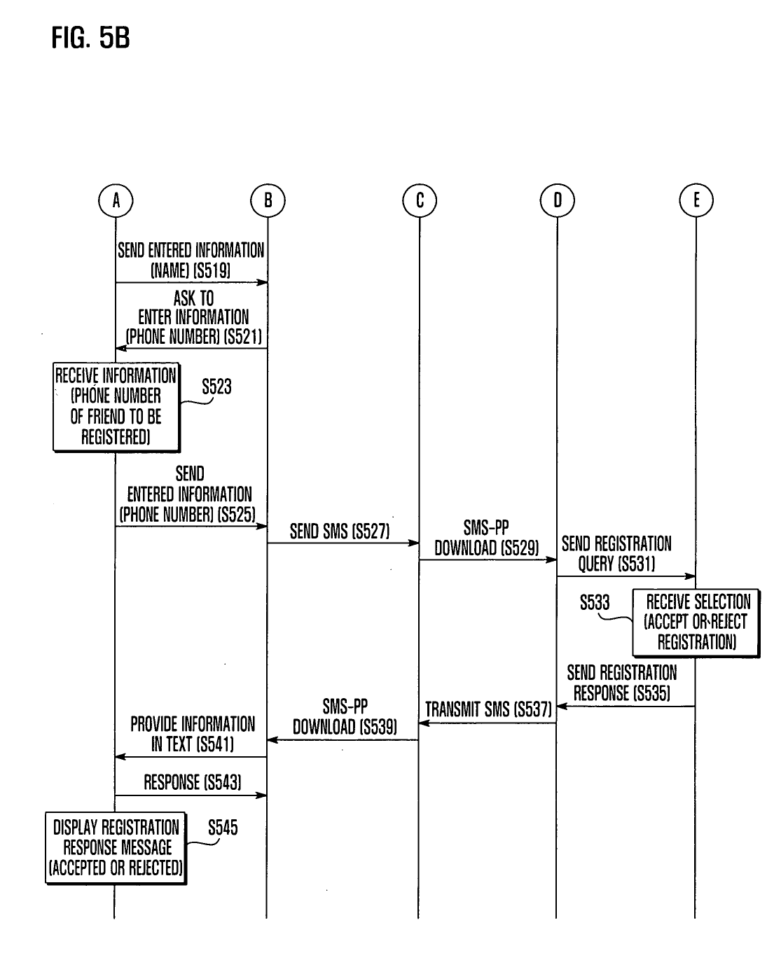

FIG. 5 is a message flow diagram illustrating a terminal registration procedure of a location information acquisition method according to an exemplary embodiment of the present invention.

In FIG. 5, the service target terminal is referred to as second mobile terminal 100b provided with a second SIM card 110b. The second mobile terminal 100b is registered for the location service. The second mobile terminal 100b provides the first mobile terminal 100a with its location information when the location information is requested. The first mobile terminal 100a is provided with a first SIM card 110a.

Referring to FIGS. 1 to 5, the first SIM card 110a supplies menu items to the first mobile terminal 100a (S501). Upon receipt of the menu items, the first mobile terminal 100a sends a response to the first SIM card 110a (S503). In more detail, the first SIM card 110a sends a SET UP MENU command providing the menu items to the first mobile terminal 100a, and the first mobile terminal 100a sends a Terminal Response of SET UP MENU command to the first SIM card 110a.

Next, the first mobile terminal 100a displays the menu items provided by the first SIM card 110a and receives a selection of one of the menu items from a user (S505). Here, the display unit 103 of the first mobile terminal 100a displays the menu items such that the user selects one of the menu items (e.g., the SAT menu item) using the key input unit 107.

If a menu item is selected, the first mobile terminal 100a informs the first SIM card 110a of the selected menu item (S507), and the first SIM card 110a provides the first mobile terminal 100a with submenu items of the selected menu item (S509). The menu selection is reported using a Menu Selection command, and the submenu items are provided using a SELECT ITEM command.

If the submenu items are received, the display unit 103 of the first mobile terminal 100a displays the submenu items and receives a selection of one of the submenu items from the user (S511). In this embodiment, it is assumed that a friend registration menu item is selected among the submenu items of the SAT menu.

Accordingly, the first mobile terminal 100a informs the first SIM card 110a of the selection of the friend registration item (S513). Upon receipt of the selection information, the first SIM card 110a sends a GET INPUT command to the first mobile terminal 100a for requesting a name of the friend to be registered (S515).

In response to the GET INPUT command, the first mobile terminal 100a receives the name of the friend from the user (S517). The user enters the name of the friend using the key input unit 107. If the name of the friend is received, the first mobile terminal 100a sends the entered name to the first SIM card 110a (S519). Upon receipt of the name, the first SIM card 110a sends the GET INPUT command to the first mobile terminal 100a for requesting more information such as phone number of the friend (S521).

Upon receipt of the GET INPUT command, the first mobile terminal 100a receives a phone number of the friend (S523). The user enters the phone number of the friend using the key input unit 107. Next, the first mobile terminal 100a sends the phone number to the first SIM card 110a (S525).

If the phone number is received, the first SIM card 110a transmits an SMS message for requesting registration of the friend to the network 105 (S527). The SMS message is transmitted in the form of a SEND SM command. Upon receipt of the SEND SM command, the network 150 transmits a SMS-PP DOWNLOAD command to the second SIM card 110b of the second mobile terminal 100b (S529).

Upon receipt of the SMS-PP-DOWNLOAD command, the second SIM card 110b sends a registration query asking whether to accept the friend registration to the second mobile terminal 100b (S531), and the second mobile terminal 100b receives a selection command from a second user (S533). The registration query is sent in the form of a GET INPUT command, and the second mobile terminal 100b displays on the display unit 103 in the form of a popup message. The second user selects YES or NO in response to the registration query.

The second mobile terminal 100b sends the registration response to the second SIM card 110b (S535). If the selection response is received, the second SIM card 110b transmits the registration response to the network 150 (S537), and the network 150 transmits the registration response to the first SIM card 110a (S539). Here, the second SIM card 100b transmits the registration response in the form of a SEND SM command, and the network 150 transmits the registration response in the form of a SMS-PP DOWNLOAD command.

Upon receipt-of the registration response, the first SIM card 110a sends a DISPLAY TEXT command to the first mobile terminal 100a (S541), and the first mobile terminal 100a sends Terminal Response of DISPLAY TEXT command to the first SIM card 110a (S543).

Next, the first mobile terminal 100a displays the registration response message on the display unit 103 (S545). The registration response message (i.e., registration accept or registration reject message) is presented in text. The registration response message is stored in the first SIM card 110a.

When a forced registration option is set, the first mobile terminal 100a can forcibly register the second mobile terminal 100b after performing step S525. For example, when the user selects a forced registration menu item at step S505, the first mobile terminal. 100a performs the forced registration regardless of the receipt of the registration accept messaged from the second mobile terminal 100b.

A location request procedure of the location information acquisition method of the present invention is described hereinafter in more detail.

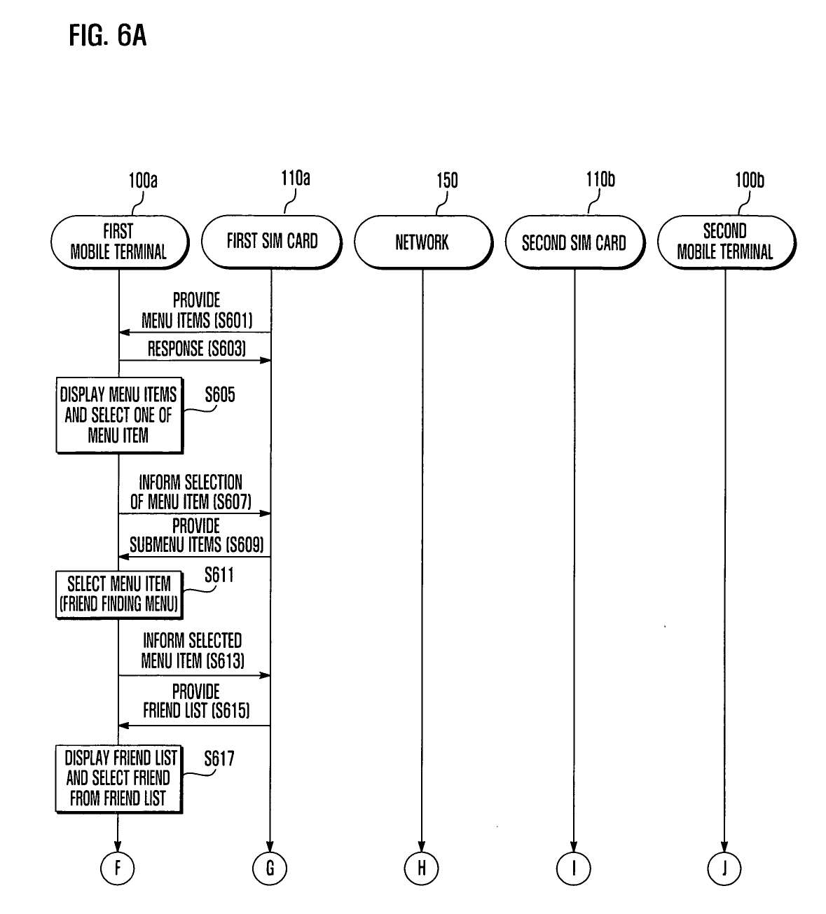

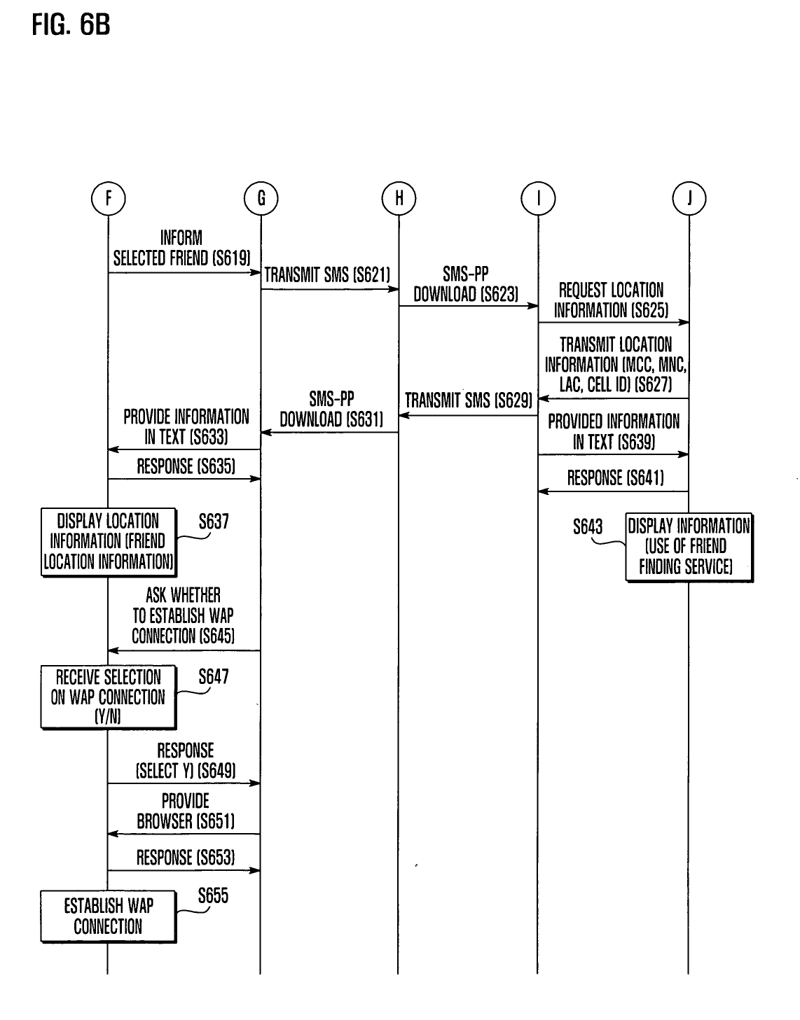

FIG. 6 is a message flow diagram illustrating a location request procedure of a location information acquisition method according to an exemplary embodiment of the present invention.

Referring to FIGS. 1 to 6, the first SIM card 110a sends a set of menu items to the first mobile terminal 100a (S601). Upon receipt of the menu items, the first mobile terminal 100a sends a response to the first SIM card 110a (S603). The menu items are sent to the first mobile terminal 100a in the form of a SET UP MENU command, and the response is sent to the first SIM card 110a in the form of a Terminal Response of SET UP MENU command.

The first mobile terminal 100a displays the menu items on the display unit 103 and receives a selection of one of menu items from the user (S605). The display unit 103 of the first mobile terminal 100a displays the menu items, and the user selects a menu item (SAT menu item in this embodiment) using the key input unit 107.

If a menu item is selected, the first mobile terminal 100a informs the first SIM card 110a of the selected menu item (S607). Upon receipt of the information on the selected menu item, the first SIM card 110a provides the first mobile terminal 100a with submenu items of the SAT menu item (S609). Here, the first mobile terminal 100a sends a Menu Selection command to the first SIM card 110a, and the first SIM card 110a sends a SELECT ITEM command to the first mobile terminal 100a.

Next, the first mobile terminal 110a displays the submenu items on the display unit 103 and receives a selection of a submenu item from the user (S611). In this embodiment, it is assumed that the user selects a submenu item of a “find friend” menu item among the SAT submenu items.

Accordingly, the first mobile terminal 100a informs the first SIM card 110a of the selection of “find friend” menu (S613). In response to the “find friend” menu selection information, the first SIM card 110a provides the first mobile terminal 100a with a registered friend list (available terminal list) (S615). The registered friend list is sent in the form of a SELECT ITEM command. In a case that no registered friend list exists, the friend registration procedure can be performed as in FIG. 5.

Upon receipt of the registered friend list, the first mobile terminal 100a displays the registered friend list on the display unit 103 and receives a selection of one of friends listed on the registered friend list from the user (S617). If a friend is selected from the registered friend list, the first mobile terminal 100a informs the first SIM card 110 of a selected friend (S619) and transmits an SMS message to the network 150 for requesting location information of the mobile terminal of the selected friend (i.e., the second mobile terminal 100b) (S621). The SMS message is transmitted in the form of a SEND SM command. If the SMS message is received, the network 150 transmits a SMS-PP DOWNLOAD command to the second SIM card 110b of the second mobile terminal 100b (S623).

Upon receipt of the SMS-PP DOWNLOAD command, the second SIM card 110b request location information of the second mobile terminal 100b (S625), and the second mobile terminal 100b sends its location information to the second SIM card 110b (S627). The location information request is sent to the second mobile terminal 100b in the form of a PROVIDE LOCAL INFORMATION command.

The location of the second mobile terminal 100b can be obtained using a GPS. The location of the second mobile terminal 100b also can be obtained by a trigonometric measurement based on the signals transmitted by three base stations in vicinity. Also, the location of the second mobile terminal 100b can be estimated using the mobile country code (MCC), mobile network code (MNC), location area code (LAC), and cell ID contained in the PROVIDE LOCAL INFORMATION command.

Upon receipt of the location information, the second SIM card 110b transmits the location information to the network 150 using an SMS (S629). The network 150 transmits the location information to the first SIM card 110a (S631). The second SIM card 110b transmits the location information to the network 150 in the form of SEND SM command, and the network 150 transmits the location information to the first SIM card 110a in the form of the SMS-PP DOWNLOAD command (S631).

Next, the first SIM card 110a provides the location information to the first mobile terminal 100a in the form of a text (S633), and the first mobile terminal 100a responds (S635). The first SIM card 110a sends the location information to the first mobile terminal 100a in the form of DISPLAY TEXT command, and the first mobile terminal 100a sends a Terminal Response of DISPLAY TEXT command to the first SIM card 110a. At this time, the first mobile terminal 100a displays the location information of the second mobile terminal 100b on the display unit 103 (S637).

The location information of the second mobile terminal 100b is displayed on the display unit 103 of the first mobile terminal 100a in text. The location information is transmitted by the second mobile terminal 100b in the form of a code at step S627. This location information code is converted into a short message format and transmitted from the second SIM card 110b to the network 150 in the form of SEMD SM command at step S629. Next, the network 150 transmits the location information to the first SIM card 110a in the form of SMS at step S631. Consequently, the location information is sent to the first mobile terminal 100a in the form of the DISPLAY TEXT command at step S633.

If the location information is sent to the second SIM card 110b at step S627, the second SIM card 110b provides the second mobile terminal 100b with a text (S639). The second mobile terminal 100b replies in response to the text (S641). The text is sent to the second mobile terminal 100b in the form of a DISPLAY TEXT command, and the response is sent to the second SIM card 110b in the form of a Terminal Response of DISPLAY TEXT command. Next, the second mobile terminal 100b display a message indicating that the “find friend” menu is used (S643). The display of the “find friend” menu can be skipped according to a preset option.

In the meantime, while the first mobile terminal 100a displays the location information of the second mobile terminal 100b on the display unit 103, the first SIM card 110a requests whether to establish a WAP connection to the first mobile terminal 100a (S645). Here, the first SIM card 110a sends a GET INKEY command to the first mobile terminal 100a for asking whether to display the location information in the form of a map.

The first mobile terminal 100a checks whether a WAP connection is confirmed and receives, when the WAP connection is confirmed, information associated with the WAP connection (S647). At this time, the display unit 103 of the first mobile terminal 100a presents a popup message with YES and NO options such that the user can select YES or NO.

If YES option is selected, the first mobile terminal 100a sends a WAP connection request to the first SIM card 110a (S649). Upon receipt of the WAP connection request, the first SIM card 110a sends a LAUNCH BROWSER command to activate a browser (S651). The first mobile terminal 100a replies by sending a Terminal Response of LAUNCH BROWSER command to the first SIM card 110a (S653) and establishes a WAP connection (S655), whereby the location information of the second mobile terminal 100b is displayed in the form of a map. At this time, the control unit 109 of the first mobile terminal 100a establishes a connection to a URL and displays the location of the second mobile terminal 100b on a map provided at the URL in more detail.

As described above, the location information acquisition method for a mobile terminal according to the present invention enables acquiring location information of a specific mobile terminal in cost-effective manner through a simplified manipulation of menu items provided by SAT of SIM card.

Also, the location information acquisition method of the present invention allows an identified subscriber to register a missing mobile terminal for a location service forcibly without service registration alert at the mobile terminal, thereby facilitating location of the missing mobile terminal.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A location information acquisition method for a mobile terminal operating with a subscriber identity module (SIM) having a SIM Application Toolkit, comprising:
registering, when a terminal registration menu item provided by the subscriber identity module is selected, an intended terminal indicated by a name and a phone number entered by a user with the subscriber identity module;
selecting, when a location request menu item provided by the subscriber identity module is selected, one of terminals registered with the subscriber identity module according to the user's intention; and
acquiring location information of the selected terminal, the location information being received in response to a location information request transmitted by the mobile terminal.

2. The location information acquisition method of claim 1, wherein registering an intended terminal comprises:
transmitting a service registration request to the intended terminal; and
registering the intended terminal with the subscriber identity module upon receipt of service registration response from the intended terminal.

3. The location information acquisition method of claim 1, wherein registering an intended terminal comprises displaying, at the intended terminal, a message asking a user of the intended terminal whether to accept or reject the registration of the intended terminal.

4. The location information acquisition method of claim 1, wherein acquiring location information of the selected terminal comprises displaying, at the intended terminal, a message indicating use of the location information.

5. The location information acquisition method of claim 1, wherein the location information is one of the group consisting of a mobile country code (MCC), a mobile network code (MNC), a location area code (LAC), and a cell ID.

6. The location information acquisition method of claim 1, wherein the location information is obtained at the intended terminal using differences of arrival times of signals transmitted by three neighbor base stations.

7. The location information acquisition method of claim 1, further comprising connecting, when a wireless application protocol (WAP) connection menu item provided by the subscriber identity module is selected, to a WAP server indicated by a predetermined uniform resource locator (URL) using a WAP browser provided by the subscriber identity module.

8. A mobile terminal comprising:
a subscriber identity module (SIM) having a SIM Application Toolkit (SAT) which provides the mobile terminal with menu items;
a control unit which registers, when a terminal registration menu item provided by the subscriber identity module is selected, an intended terminal indicated by a name and a phone number entered by a user with the subscriber identity module, selects, when a location request menu item provided by the subscriber identity module is selected, one of terminals registered with the subscriber identity module according to the user's intention, requests a location information of the intended terminal, and analyzes the location information received from the selected terminal; and
a display unit which displays, when the location request menu item is selected, an information on the mobile terminal registered with the subscriber identity module, and displays, when receiving the location information, the location information analyzed by the control unit.

9. The mobile terminal of claim 8, wherein the control unit transmits a service registration request to the intended terminal and registers the intended terminal with the subscriber identity module upon receipt of a service registration response from the intended terminal.

10. The mobile terminal of claim 8, wherein the location information is one from the group consisting of a country code, a network operator code, a location code, and a cell identity information.

11. The mobile terminal of claim 8, wherein the location information is obtained at the intended terminal using differences of arrival times of signals transmitted by three neighbor base stations.

12. The mobile terminal of claim 8, wherein the control unit connects, when a wireless application protocol (WAP) connection menu item provided by the subscriber identity module is selected, to a WAP server indicated by a predetermined uniform resource locator (URL) using a WAP browser provided by the subscriber identity module.
